(19) United States
(12) Patent Application Publication
(10) Pub. No.: US 2004/0153813 A1
(43) Pub. Date: Aug. 5, 2004

(54) Apparatus and method for synchronization of trace streams from multiple processors

(76) Inventor: Gary L. Swoboda, Sugar Land, TX (US)

Correspondence Address: TEXAS INSTRUMENTS INCORPORATED, P O BOX 655474, M/S 3999, DALLAS, TX, 75265

(21) Appl. No.: 10/728,627

(22) Filed: Dec. 5, 2003

Related U.S. Application Data
(60) Provisional application No. 60/434,086, filed on Dec. 17, 2002.

(51) Int. Cl. H04L 1/22

(52) U.S. Cl. 714/36

(57) ABSTRACT

In order to synchronize the testing of a plurality of target processors, a global synchronization signal is applied to the simultaneously to the trace generation apparatus of each of the target processors. The trace generation apparatus generates a global sync marker that is included in at least one of the trace streams of each target processor. The sync marker relates the occurrence of the global synchronization signal to system clock and to the program execution of the target processor issuing the global sync marker. In this manner, the relationship between the operations of each of a plurality of target processors can be reconstructed by the host processing unit.

### RELATED APPLICATIONS

This application claims priority under 35 USC §119(e) (1) of Provisional Application No. 60/434,086 (TI-34654P) filed Dec. 17, 2002.

U.S. patent application (Attorney Docket No. TI-34655), entitled APPARATUS AND METHOD FOR SEPARATING DETECTION AND ASSERTION OF A TRIGGER EVENT, invented by Gary L. Swoboda, filed on even date herewith, and assigned to the assignee of the present application; U.S. patent application (Attorney Docket No. TI-34656), entitled APPARATUS AND METHOD FOR STATE SELECTABLE TRACE STREAM GENERATION, invented by Gary L. Swoboda, filed on even date herewith, and assigned to the assignee of the present application; U.S. patent application (Attorney Docket No. TI-34657), entitled APPARATUS AND METHOD FOR SELECTING PROGRAM HALTS IN AN UNPROTECTED PIPELINE AT NON-INTERRUPTIBLE POINTS IN CODE EXECUTION, invented by Gary L. Swoboda and Krishna Allam, filed on even date herewith, and assigned to the assignee of the present application; U.S. patent application (Attorney Docket No. TI-34658), entitled APPARATUS AND METHOD FOR REPORTING PROGRAM HALTS IN AN UNPROTECTED PIPELINE AT NON-INTERRUPTIBLE POINTS IN CODE EXECUTION, invented by Gary L. Swoboda, filed on even date herewith, and assigned to the assignee of the present application; U.S. patent application (Attorney Docket No. TI-34659), entitled APPARATUS AND METHOD FOR A FLUSH PROCEDURE IN AN INTERRUPTED TRACE STREAM, invented by Gary L. Swoboda, filed on even date herewith, and assigned to the assignee of the present application; U.S. patent application (Attorney Docket No. TI-34660), entitled APPARATUS AND METHOD FOR CAPTURING AN EVENT OR COMBINATION OF EVENTS RESULTING IN A TRIGGER SIGNAL IN A TARGET PROCESSOR, invented by Gary L. Swoboda, filed on even date herewith, and assigned to the assignee of the present application; U.S. patent application (Attorney Docket No. TI-34661), entitled APPARATUS AND METHOD FOR CAPTURING THE PROGRAM COUNTER ADDRESS ASSOCIATED WITH A TRIGGER SIGNAL IN A TARGET PROCESSOR, invented by Gary L. Swoboda, filed on even date herewith, and assigned to the assignee of the present application; U.S. patent application (Attorney Docket No. TI-34662), entitled APPARATUS AND METHOD DETECTING ADDRESS CHARACTERISTICS FOR USE WITH A TRIGGER GENERATION UNIT IN A TARGET PROCESSOR, invented by Gary Swoboda and Jason L. Peck, filed on even date herewith, and assigned to the assignee of the present application; U.S. patent application (Attorney Docket No. TI-34663), entitled APPARATUS AND METHOD FOR TRACE STREAM IDENTIFICATION OF A PROCESSOR RESET, invented by Gary L. Swoboda, Bryan Thome and Manisha Agarwala, filed on even date herewith, and assigned to the assignee of the present application; U.S. patent (Attorney Docket No. TI-34664), entitled APPARATUS AND METHOD FOR TRACE STREAM IDENTIFICATION OF A PROCESSOR DEBUG HALT SIGNAL, invented by Gary L. Swoboda, Bryan Thome, Lewis Nardini and Manisha Agarwala, filed on even date herewith, and assigned to the assignee of the present application; U.S. patent application (Attorney Docket No. TI-34665), entitled APPARATUS AND METHOD FOR TRACE STREAM IDENTIFICATION OF A PIPELINE FLATTENER PRIMARY CODE FLUSH FOLLOWING INITIATION OF AN INTERRUPT SERVICE ROUTINE; invented by Gary L. Swoboda, Bryan Thome and Manisha Agarwala, filed on even date herewith, and assigned to the assignee of the present application; U.S. patent application (Attorney Docket No. TI-34666), entitled APPARATUS AND METHOD FOR TRACE STREAM IDENTIFICATION OF A PIPELINE FLATTENER SECONDARY CODE FLUSH FOLLOWING A RETURN TO PRIMARY CODE EXECUTION, invented by Gary L. Swoboda, Bryan Thome and Manisha Agarwala filed on even date herewith, and assigned to the assignee of the present application; U.S. patent application (Docket No. TI-34667), entitled APPARATUS AND METHOD IDENTIFICATION OF A PRIMARY CODE START SYNC POINT FOLLOWING A RETURN TO PRIMARY CODE EXECUTION, invented by Gary L. Swoboda, Bryan Thome and Manisha Agarwala, filed on even date herewith, and assigned to the assignee of the present application; U.S. patent application (Attorney Docket No. TI-34668), entitled APPARATUS AND METHOD FOR IDENTIFICATION OF A NEW SECONDARY CODE START POINT FOLLOWING A RETURN FROM A SECONDARY CODE EXECUTION, invented by Gary L. Swoboda, Bryan Thome and Manisha Agarwala, filed on even date herewith, and assigned to the assignee of the present application; U.S. patent application (Attorney Docket No. TI-34669), entitled APPARATUS AND METHOD FOR TRACE STREAM IDENTIFICATION OF A PAUSE POINT IN A CODE EXECTION SEQUENCE, invented by Gary L. Swoboda, Bryan Thome and Manisha Agarwala, filed on even date herewith, and assigned to the assignee of the present application; U.S. patent application (Attorney Docket No. TI-34670), entitled APPARATUS AND METHOD FOR COMPRESSION OF A TIMING TRACE STREAM, invented by Gary L. Swoboda and Bryan Thome, filed on even date herewith, and assigned to the assignee of the present application; U.S. patent application (Attorney Docket No. TI-34671), entitled APPARATUS AND METHOD FOR TRACE STREAM IDENTIFCATION OF MULTIPLE TARGET PROCESSOR EVENTS, invented by Gary L. Swoboda and Bryan Thome, filed on even date herewith, and assigned to the assignee of the present application; and U.S. patent application (Attorney Docket No. TI-34672 entitled APPARATUS AND METHOD FOR OP CODE EXTENSION IN PACKET GROUPS TRANSMITTED IN TRACE STREAMS, invented by Gary L. Swoboda and Bryan Thome, filed on even date herewith, and assigned to the assignee of the present application are related applications.

### BACKGROUND OF THE INVENTION

1. Field of the Invention

This invention relates generally to the testing of digital signal processing units and, more particularly, to the testing of semiconductor chips and devices having multiple processor units executing coordinated procedures. During a test and debug procedure, each of the processor generates at least one data streams. The plurality of data streams from the several processing units must be coordinated procedure to analyze the procedure being executed by the processing units.

2. Description of Related Art

As microprocessors and digital signal processors have become increasingly complex, advanced techniques have been developed to test these devices. Dedicated apparatus is available to implement the advanced techniques. Referring to FIG. 1A, a general configuration of the apparatus used in the test and debug of a target processor 12 is shown. The test and debug procedures operate under control of a host processing unit 10. The host processing unit 10 applies control signals to the emulation unit 11 by connector cable 14 and receives (test) data signals from the emulation unit 11 by connector cable 14. The emulation unit 11 applies control signals to and receives (test) signals from the target processing unit 12 by connector cable 15. The emulation unit 11 can be thought of as an interface unit between the host processing unit 10 and the target processor 12. The emulation unit 11 processes the control signals from the host processor unit 10 and applies these signals to the target processor 12 in such a manner that the target processor will respond with the appropriate test signals. The test signals from the target processor 12 can be a variety types. Two of the most popular test signal types are the JTAG (Joint Test Action Group) signals and trace signals. The JTAG protocol provides standardized test procedures in wide use in which the status of selected components is determined. Trace signals are signals from a multiplicity of selected locations in the target processor 12. While the width of the bus interfacing to the host processing unit 10 generally has a standardized width, the bus between the emulation unit 11 and the target processor 12 can be increased to accommodate the amount of test data from the increasingly complex target processing unit 12. Thus, part of the interface function between the host processing unit 10 and the target processor 12 is to store the test signals until the signals can be transmitted to the host processing unit 10 by a cable typically having fewer conduct paths. The emulation unit 11 can be physically incorporated in the host processing unit 10.

As the processor technology has evolved, the number of components on a chip has increased. A single chip or component can have a multiplicity of processors fabricated thereon. In addition, the processors can be of several kinds, specialized and general purpose processors. And the several processors can be working on different aspects of the same problem, e.g., radio signal acquisition and decoding of the signals. The several processors can also be operating at different clock speeds. Referring to FIG. 1B, target processor 12 has a plurality of processor units 121A through 121N. Each processor unit 121A through 121N is coupled to a test and debug unit 122A through 122N, respectively. In fact, the test and debug apparatus 122A through 122N is typically incorporated in processor units 121A through 121N, respectively. The separation of the components in this discussion is used for purposes of description. The test and debug apparatus 122A through 122N exchange signals with the test and debug port 123.

The test and debug port 123 is coupled through cable 14 to the emulation unit 11.

During the testing of multiple processing units, the processing unit will typically be executing instruction sets independently and can even operate at different clock speeds. It is therefore important to able to relate the activity of all of the processing units so that in the event of a malfunction, the cause of the malfunction can be determined.

A need has been felt for apparatus and an associated method having the feature that a relationship between the program executions of a plurality of target processors can be determined. It would be a further feature of the present invention to determine the state of program execution of a plurality of processors upon receipt of a global synchronization signal. It would be yet another feature of the apparatus and associated method for each target processor to provide, in response to a global synchronization signal, a trace stream sync marker, the trace stream sync marker including reference to the target processor clock and to the status of the target processor program execution. It would be a still further feature of the apparatus and related method to relate the sync markers from the target processors and to determine the relative status of the program execution of the target processors.

### SUMMARY OF THE INVENTION

The aforementioned and other features are accomplished, according to the present invention, by applying a global synchronization signal to all of the target processors (and associated test and debug apparatus). Each target processor then generates a global sync marker to be included in a trace stream of each target processor. Each generated global sync marker includes an identification of the specific global synchronization signal to which the trace stream sync marker is a response and a reference to the current clock cycle in the timing trace stream at the time of the global sync marker. This information can be included in the timing trace stream and/or in a program counter trace stream. The timing trace stream and the program counter trace stream for each target processor are synchronized by periodic synchronization signals. Using the parameters of the global sync markers of the target processors, the relative status of the program execution of the plurality of target processors can be determined at the time that the global synchronization signal was issued.

Other features and advantages of present invention will be more clearly understood upon reading of the following description and the accompanying drawings and the claims.

### BRIEF DESCRIPTION OF THE DRAWINGS

FIG. 1A is a general block diagram of a system configuration for test and debug of a target processor, while FIG. 1B illustrates a chip having a plurality of target processors.

FIG. 2 is a block diagram of selected components in the target processor used the testing of the central processing unit of the target processor according to the present invention.

FIG. 3 is a block diagram of selected components of the illustrating the relationship between the components transmitting trace streams in each target processor.

FIG. 4A illustrates format by which the timing packets are assembled according to the present invention, while

FIG. 4B illustrates the format of the sync marker in the timing packets according to the present invention.

FIG. 5 illustrates the possible parameters for sync markers in the program counter stream packets according to the present invention.

FIG. 6A illustrates the sync markers in the program counter trace stream when a periodic sync point ID is generated, while FIG. 6B illustrates the reconstruction of the target processor operation from the trace streams according to the present invention.

FIG. 7A is a block diagram illustrating the apparatus used in reconstructing the processor operation from the trace streams according to the present invention, while

FIG. 7B is block diagram illustrating where the program counter identification of instructions is provided for the trace streams according to the present invention.

FIG. 8A is schematic diagram of illustrating the generation of a program counter sync marker; while FIG. 8B illustrates the sync markers generated by the presence of a periodic sync ID signal; and FIG. 8C illustrates the reconstruction of the processor operation from the trace stream according to the present invention.

### DESCRIPTION OF THE PREFERRED EMBODIMENT

### 1. Detailed Description of the Figures

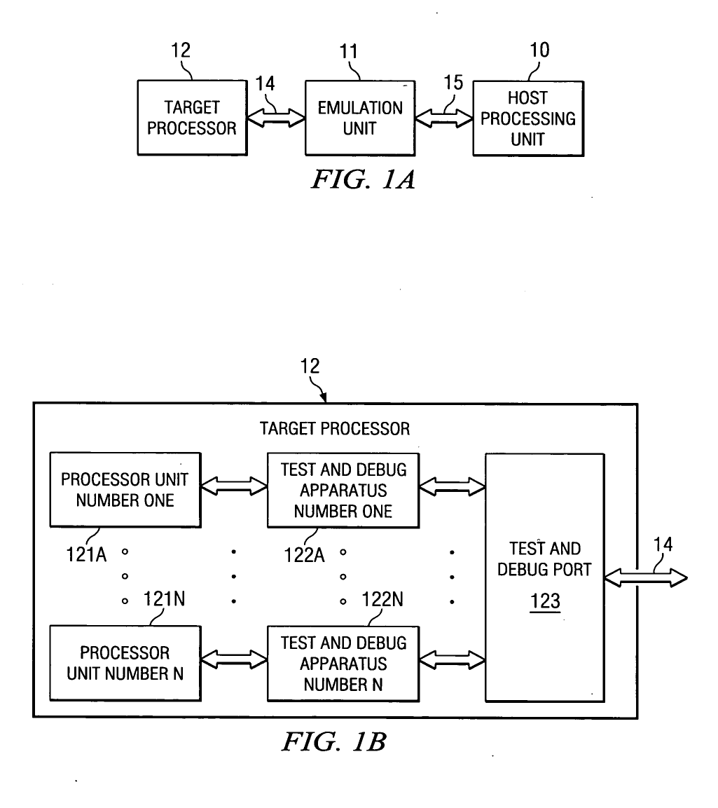

FIG. 1A and FIG. 1B have been described with respect to the related art.

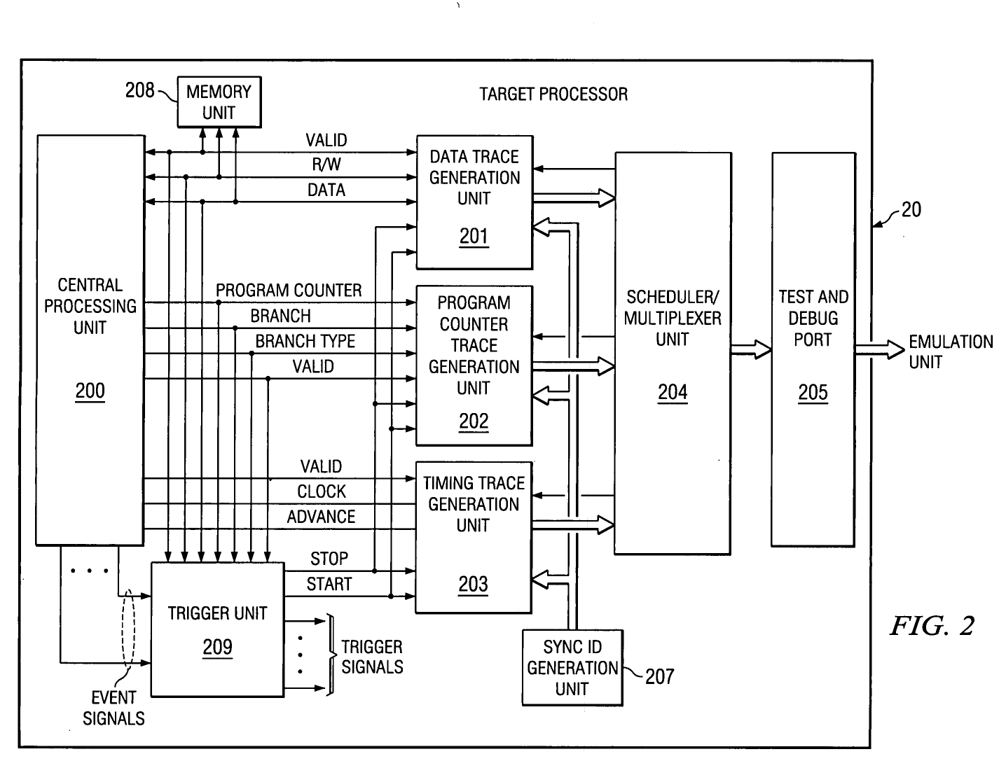

Referring to FIG. 2, a block diagram of selected components of a target processor 20, according to the present invention, is shown. The target processor includes at least one central processing unit 200 and a memory unit 208. The central processing unit 200 and the memory unit 208 are the components being tested. The trace system for testing the central processing unit 200 and the memory unit 202 includes three packet generating units; a data packet generation unit 201, a program counter packet generation unit 202 and a timing packet generation unit 203. The data packet generation unit 201 receives VALID signals, READ/WRITE signals and DATA signals from the central processing unit 200. After placing the signals in packets, the packets are applied to the scheduler/multiplexer unit 204 and forwarded to the test and debug port 205 for transfer to the emulation unit 11. The program counter packet generation unit 202 receives PROGRAM COUNTER signals, VALID signals, BRANCH signals, and BRANCH TYPE signals from the central processing unit 200 and, after forming these signal into packets, applies the resulting program counter packets to the scheduler/multiplexer 204 for transfer to the test and debug port 205. The timing packet generation unit 203 receives ADVANCE signals, VALID signals and CLOCK signals from the central processing unit 200 and, after forming these signals into packets, applies the resulting packets to the scheduler/multiplexer unit 204 and the scheduler/multiplexer unit 204 applies the packets to the test and debug port 205. Trigger unit 209 receives EVENT signals from the central processing unit 200 and DATA signals that are applied to the data trace generation unit 201, the program counter trace generation unit 202, and the timing trace generation unit 203. The trigger unit 209 applies TRIGGER and CONTROL signals to the central processing unit 200 and applies CONTROL (i.e., STOP and START) signals to the data trace generation unit 201, the program counter trace generation unit 202, and the timing trace generation unit 203. The sync ID generation unit 207 applies signals to the data trace generation unit 201, the program counter trace generation unit 202 and the timing trace generation unit 203. As indicated above, the test and debug apparatus components are shown as being separate from the central processing unit 201. It will be clear that an implementation these components can be integrated with the components of the central processing unit 200.

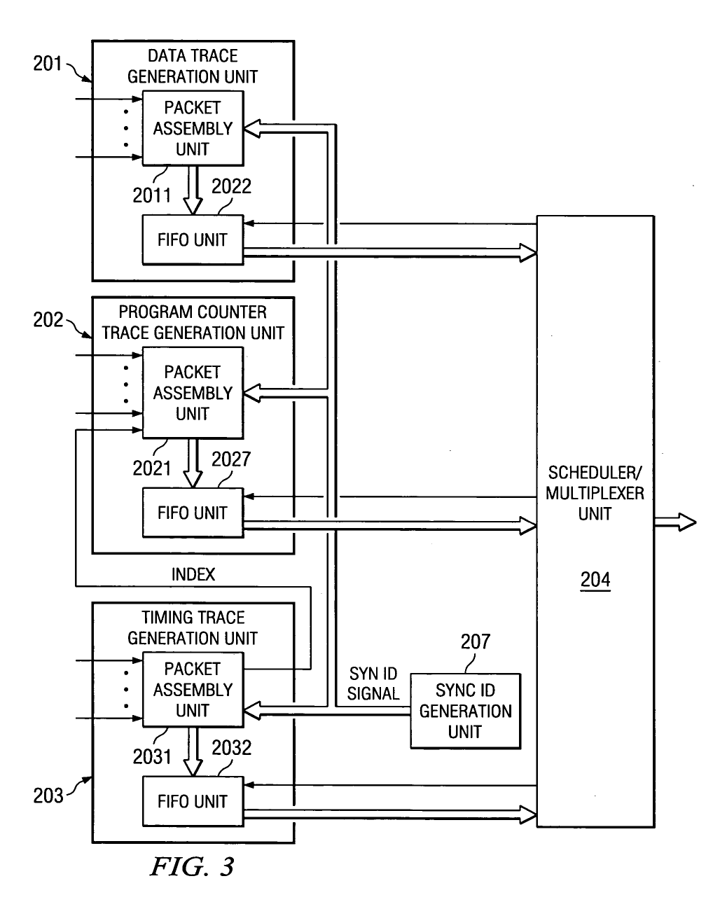

Referring to FIG. 3, the relationship between selected components in the target processor 20 is illustrated. The data trace generation unit 201 includes a packet assembly unit 2011 and a FIFO (first in/first out) storage unit 2012, the program counter trace generation unit 202 includes a packet assembly unit 2021 and a FIFO storage unit 2022, and the timing trace generation unit 203 includes a packet generation unit 2031 and a FIFO storage unit 2032. As the signals are applied to the packet generators 201, 202, and 203, the signals are assembled into packets of information. The packets in the preferred embodiment are 10 bits in width. Packets are assembled in the packet assembly units in response to input signals and transferred to the associated FIFO unit. The scheduler/multiplexer 204 generates a signal to a selected trace generation unit and the contents of the associated FIFO storage unit are transferred to the scheduler/multiplexer 204 for transfer to the emulation unit 11. Also illustrated in FIG. 3 is the sync ID generation unit 207. The sync ID generation unit 207 applies a SYNC ID signal to the packet assembly unit of each trace generation unit. A signal group related to the SYNC ID, a counter signal in the preferred embodiment, is included in a current packet and transferred to the associated FIFO unit. The packet resulting from the SYNC ID signal in each trace is transferred to the emulation unit 11 and then to the host processing unit. In the host processing unit, the same count in each trace stream indicates that the point at which the trace streams are synchronized. In addition, the packet assembly unit 2031 of the timing trace generation unit 203 applies an INDEX signal to the packet assembly unit 2021 of the program counter trace generation unit 202. The function of the INDEX signal will be described below.

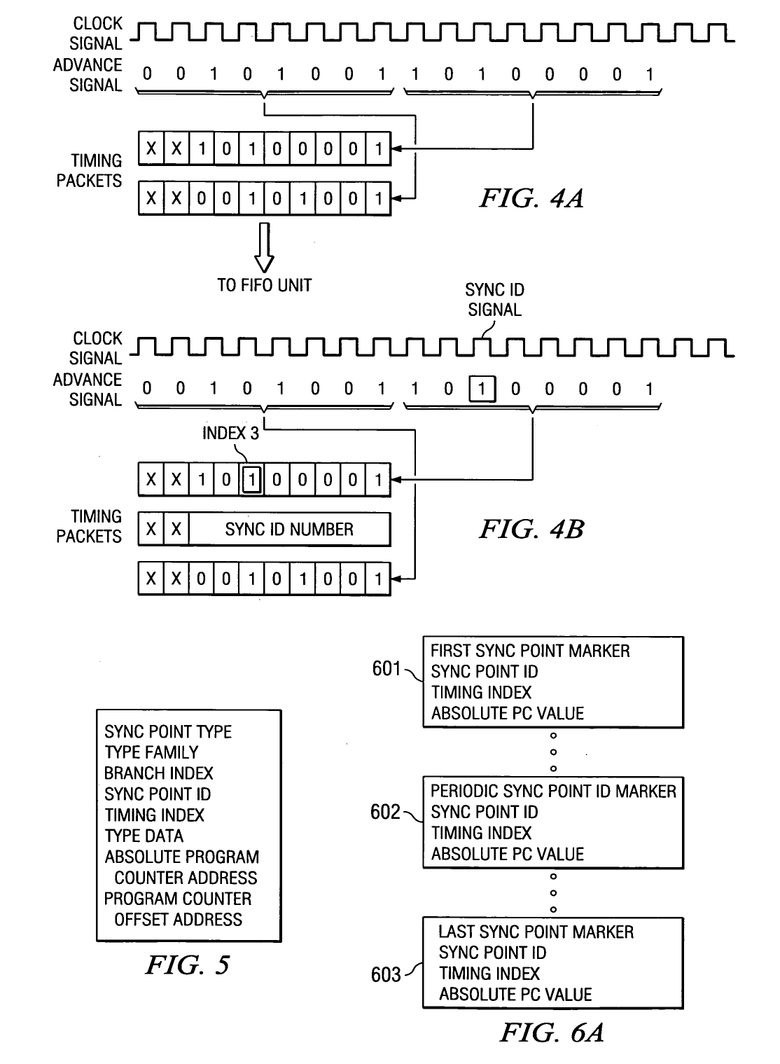

Referring to FIG. 4A, the assembly of timing packets is illustrated. The signals applied to the timing trace generation unit 203 are the CLOCK signals and the ADVANCE signals. The CLOCK signals are system clock signals to which the operation of the central processing unit 200 is synchronized. The ADVANCE signals indicate an activity such as a pipeline advance or program counter advance (0) or a pipeline non-advance or program counter non-advance (1). An ADVANCE or NON-ADVANCE signal occurs each clock cycle. The timing packet is assembled so that the logic signal indicating ADVANCE or NON-ADVANCE is transmitted at the position of the concurrent CLOCK signal. These combined CLOCK/ADVANCE signals are divided into groups of 8 signals, assembled with two control bits in the packet assembly unit 2031, and transferred to the FIFO storage unit 2032.

Referring to FIG. 4B, the trace stream generated by the timing trace generation unit 203 is illustrated. The first (in time) trace packet is generated as before. During the assembly of the second trace packet, a SYNC ID signal is generated during the third clock cycle. The timing packet assembly unit 2031 assembles and transmits a packet in response to the SYNC ID signal that includes the sync ID number. The next timing packet is only partially assembled at the time of the SYNC ID signal. In the present example, the SYNC ID signal occurs during the third clock cycle of the formation of this timing packet. The timing packet assembly unit 2031 generates a TIMING INDEX 3 signal (for the third packet clock cycle at which the SYNC ID signal occurs) and transmits this TIMING INDEX 3 signal to the program counter packet assembly unit 2031 for inclusion in a periodic sync marker in the program counter trace stream. The timing packet assembly unit 2031 completes the assembly of the packet with the clock cycle wherein the SYNC ID signal occurred and forwards this packet to the FIFO unit 2032.

Referring to FIG. 5, the parameters of a sync marker in the program counter trace stream, according to the present invention is shown. The program counter stream sync markers each have a plurality of packets associated therewith. The packets of each sync marker can transmit a plurality of parameters. A SYNC POINT TYPE parameter defines the event described by the contents of the accompanying packets. A program counter TYPE FAMILY parameter provides a context for the SYNC POINT TYPE parameter and is described by the first two most significant bits of a second header packet. A BRANCH INDEX parameter in all but the final SYNC POINT points to a bit within the next relative branch packet following the SYNC POINT. When the program counter trace stream is disabled, this index points a bit in the previous relative branch packet when the BRANCH INDEX parameter is not a logic “0”. In this situation, the branch register will not be complete and will be considered as flushed. When the BRANCH INDEX is a logic “0”, this value point to the least significant value of branch register and is the oldest branch in the packet. A SYNC ID parameter matches the SYNC POINT with the corresponding TIMING and/or DATA SYNC POINT which are tagged with the same SYNC ID parameter. A TIMING INDEX parameter is applied relative to a corresponding TIMING SYNC POINT. For all but LAST POINT SYNC events, the first timing packet after the TIMING PACKET contains timing bits during which the SYNC POINT occurred. When the timing stream is disabled, the TIMING INDEX points to a bit in the timing packet just previous to the TIMING SYNC POINT packet when the TIMING INDEX value is nor zero. In this situation, the timing packet is considered as flushed. A TYPE DATA parameter is defined by each SYNC TYPE. An ABSOLUTE PC VALUE is the program counter address at which the program counter trace stream and the timing information are aligned. An OFFSET COUNT parameter is the program counter offset counter at which the program counter and the timing information are aligned.

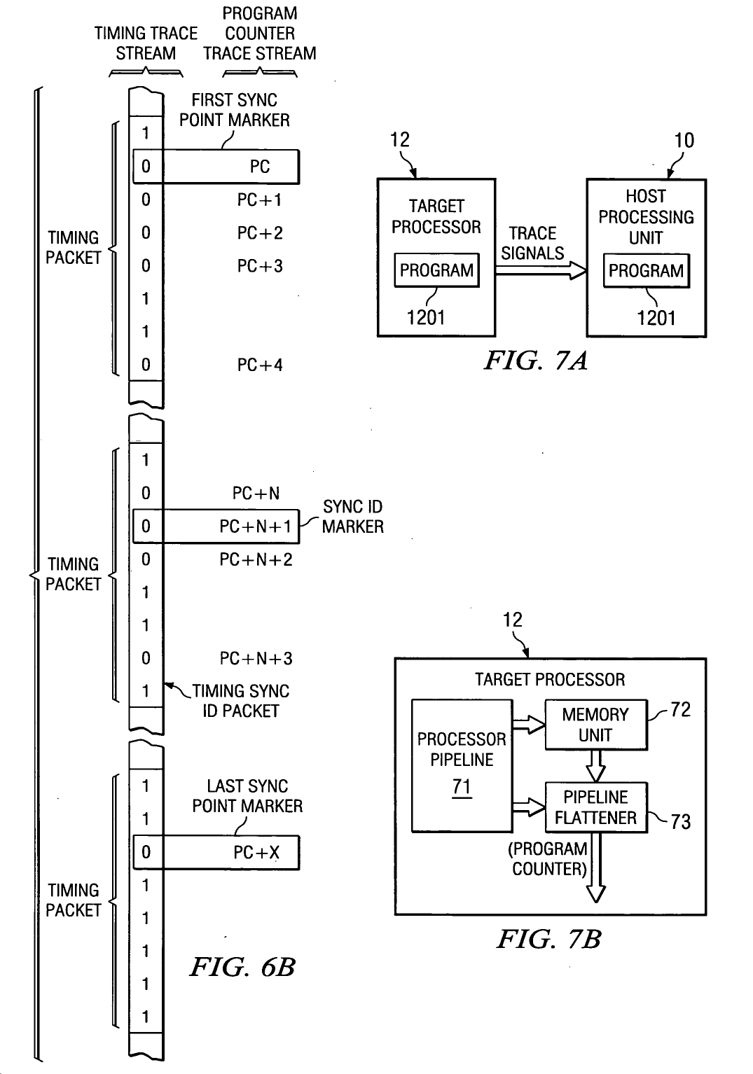

Referring to FIG. 6A, a program counter trace stream for a hypothetical program execution is illustrated. In this program example, the execution proceeds without interruption from external events. The program counter trace stream will consist of a first sync point marker 601, a plurality of periodic sync point ID markers 602, and last sync point marker 603 designating the end of the test procedure. The principal parameters of each of the packets are a sync point type, a sync point ID, a timing index, and an absolute PC value. The first and last sync points identify the beginning and the end of the trace stream. The sync ID parameter is the value from the value from the most recent sync point ID generator unit. In the preferred embodiment, this value in a 3-bit logic sequence. The timing index identifies the status of the clock signals in a packet, i.e., the position in the 8 position timing packet when the event producing the sync signal occurs. The absolute address of the program counter is provided for the program counter address the time of the event causing the sync packet. Based on this information, the events in the target processor can be reconstructed by the host processor.

Referring to FIG. 6B, the reconstruction of the program execution from the timing and program counter trace streams is illustrated. The timing trace stream consists of packets of 8 logic “0”s and logic “1”s. The logic “0”s indicate that either the program counter or the pipeline is advanced, while the logic “1”s indicate the either the program counter or the pipeline is stalled during that clock cycle. Because each program counter trace packet has an absolute address parameter, a sync ID, and the timing index in addition to the packet identifying parameter, the program counter addresses can be identified with a particular clock cycle. Similarly, the periodic sync points can be specifically identified with a clock cycle in the timing trace stream. In this illustration, the timing trace stream and the sync ID generating unit are in operation when the program counter trace stream is initiated. The periodic sync point is illustrative of the plurality of periodic sync points that would typically be available between the first and the last trace point, the periodic sync points permitting the synchronization of the three trace streams for a processing unit.

Referring to FIG. 7A, the general technique for reconstruction of the trace streams is illustrated. The trace streams originate in the target processor 12 as the target processor 12 is executing a program 1201. The trace signals are applied to the host processing unit 10. The host processing unit 10 also includes the same program 1201. Therefore, in the illustrative example of FIG. 6 wherein the program execution proceeds without interruptions or changes, only the first and the final absolute addresses of the program counter are needed. Using the advance/non-advance signals of the timing trace stream, the host processing unit can reconstruct the program as a function of clock cycle. Therefore, without the sync ID packets, only the first and last sync markers are needed for the trace stream. This technique results in reduced information transfer. FIG. 6B includes the presence of periodic sync ID cycles, of which only one is shown. The periodic sync ID packets are important for synchronizing the plurality of trace streams, for selection of a particular portion of the program to analyze, and for restarting a program execution analysis for a situation wherein at least a portion of the data in the trace data stream is lost. The host processor can discard the (incomplete) trace data information between two sync ID packets and proceed with the analysis of the program outside of the sync timing packets defining the lost data.

As indicated in FIG. 6A, the program counter trace stream includes the absolute address of the program counter for an instruction. Referring to FIG. 7B, each processor can include a processor pipeline 71. When the instruction leaves the processor pipeline, the instruction is entered in the pipeline flattener 73. At the same time, an access of memory unit 72 is performed. The results of the memory access of memory unit 72, which may take several clock cycles, is then merged the associated instruction in the pipeline flattener 73 and withdrawn from the pipeline flattener 73 for appropriate distribution. The pipeline flattener 73 provides a technique for maintaining the order of instructions while providing for the delay of a memory access. In the preferred embodiment, the absolute address used in the program counter trace stream is the derived from the instruction of leaving the pipeline flattener 71. As a practical matter, the absolute address is delayed by an appropriate number of cycles. It is not necessary to use a pipeline flattener 73. The instructions can have appropriate labels associated therewith to eliminate the need for the pipeline flattener 73.

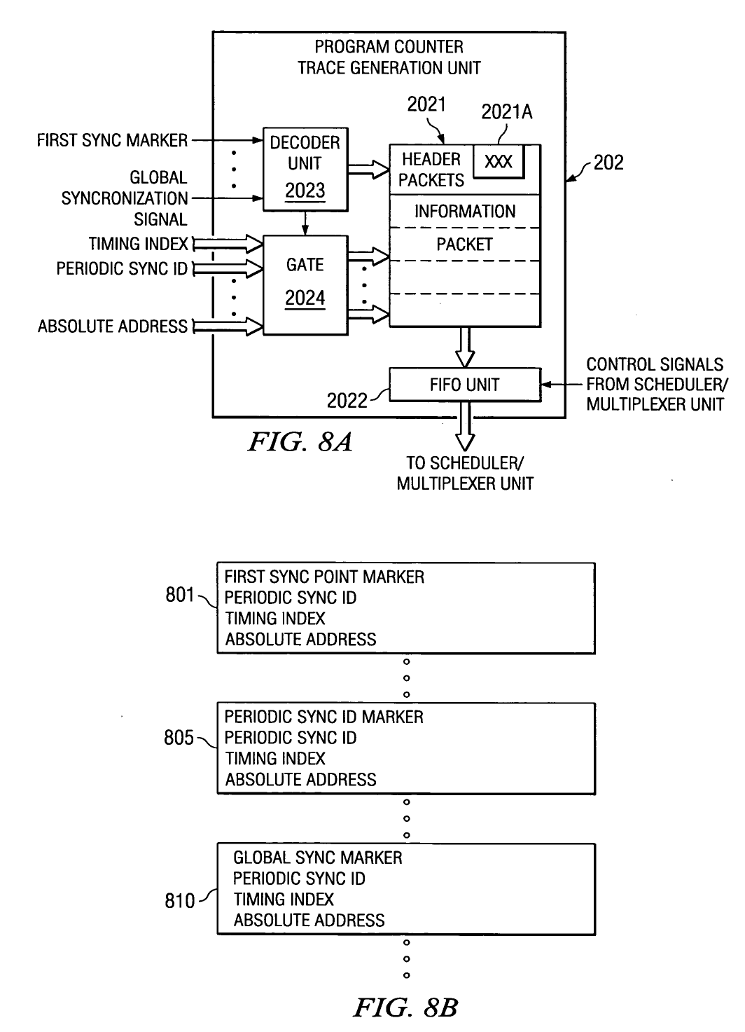

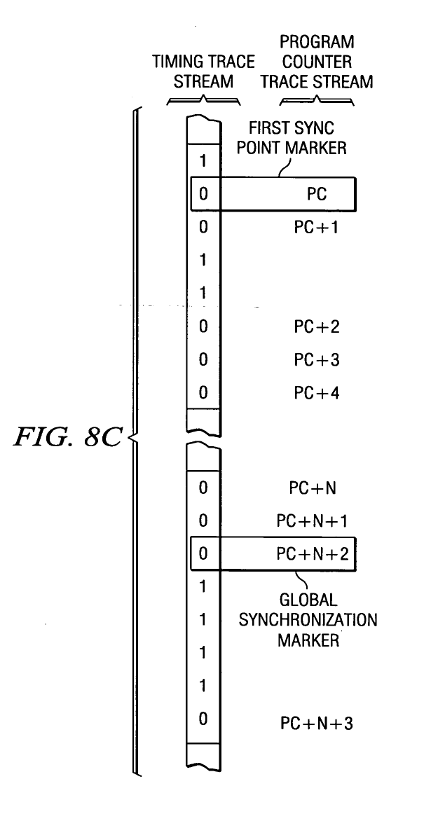

Referring to FIG. 8A, the major components of the program counter trace generation unit 202 is shown. The program counter trace generation unit 202 includes a packet assembly unit 2021, a FIFO unit 2022, a decoder unit 2023, and a gate unit 2024. PERIODIC SYNC ID signals, TIMING INDEX signals, and ABSOLUTE ADDRESS signals are applied to gate unit 2024. When the PERIODIC SYNC ID signals are incremented, a PERIODIC SYNC ID signal is applied to decoder 2023. The decoder unit 2023 identifies the applied signal as a PERIODIC SYNC ID signal, a GLOBAL SYNC signal, etc. Based on the identification, the decoder unit 2023 places an identifier in the position in a header packet in the packet assembly unit 2021 at a preselected position, i.e., 2021A. The identifier identifies the signal that has been applied to the decoder unit 2023. The applied signal results in a control signal being applied to the gate unit 2024. The control signal applied to the gate unit 2023 permits the current PERIODIC SYNC ID signals, the TIMING INDEX signals and the ABSOLUTE ADDRESS signals to be transmitted and stored in preselected locations in the packets being assembled in the packet assembly unit 2021. When the program control packet assembly unit has assembled the packets into a final form called a sync marker, then the component packets of the sync marker are transferred to the FIFO unit 2023 for eventual transmission to the scheduler/multiplexer unit. Similarly, when a GLOBAL SYNCHRONIZATION signal is generated, the global synchronization identifier is entered into location 2021A. A CONTROL signal from the decoder unit 2023 generated as a result of the GLOBAL SYNCHRONIZATION signal causes the gate 2024 to transmit the SYNC ID signals, the TIMING INDEX signals, and the ABSOLUTE ADDRESS signals and store these signals in preestablished positions program counter packet assembly unit 2021. When the global sync marker has been assembled, i.e., in packets in the packet assembly unit, the global sync marker is transferred to the FIFO unit 2023. As will be clear, the first (instruction) sync point marker and the last (instruction) sync point marker are formed in an analogous manner.

Referring to FIG. 8B, examples of the sync markers in the program counter trace stream are shown. The start of the test procedure is shown in first point sync marker 801. Thereafter, periodic sync ID markers 805 can be generated. Other event markers can also be generated. The identification of a GLOBAL SYNCHRONIZATION signal results in the generation of the global sync marker 810. PERIODIC SYNC ID signals can also be generated after the global sync marker and before the end of the instruction execution.

Referring to FIG. 8C, the reconstruction of the program counter trace stream from the sync markers of FIG. 8B and the timing trace stream is shown. The first sync point marker identifies the beginning of test procedure with a program counter address PC at a clock cycle designated by the periodic sync ID entry and the timing index entry in the first sync point marker. The program continues to execute unit with the program counter addresses being related to a particular processor clock cycle. When the GLOBAL SYNCHRONIZATION signal is generated, the program counter is at address PC+N+2 and is related to a particular clock cycle. Thereafter, the program counter does not advance as indicated by the logic “1”s associated with each clock cycle. Sync ID markers can be generated between the first sync point marker and the global synchronization marker. Periodic sync ID markers can continue to be generated, where appropriate, after the global synchronization marker.

### 2. Operation of the Preferred Embodiment

In the preferred embodiment, the present invention relies on the ability to relate the timing trace stream and the program counter trace stream. This relationship is generally provided by having periodic sync ID information transmitted in the program counter trace stream sync marker reference the timing trace stream. The timing trace stream, implemented with a series of packets, includes a packet issued at time of the periodic sync ID signal. The timing trace packets include information as to whether the program counter advanced during each clock cycle. The timing packets of the trace stream are grouped in packets of eight signals identifying whether the program counter or the pipeline advanced or did not advance. The periodic sync ID markers in the program counter stream include the periodic sync ID identification, position in the current eight position packet of the timing index, when the event occurred, and program counter-related information. Thus, the clock cycle of the periodic sync ID event can be specified. Similarly, when the global synchronization signal is received, a global synchronization sync marker is placed in the program counter trace stream. The address of the program counter is provided in the program counter sync markers so that the global synchronization event can be related to the execution of the program in each target processing unit. Typically, during the course of a test and debug procedure, a series of global synchronization signals will be issued by the testing apparatus. The header of the global sync marker will provide a field to identify the particular global synchronization marker permitting the program execution of the all of the processors to be related.

The sync marker trace steams illustrated above relate to an idealized operation of the target processor in order to emphasize the features of the present invention. As indicated by FIG. 6A, numerous other sync events (e.g. branch events) will typically be communicated by means of the program counter trace stream sync markers. And in some cases, a program counter index can replace the absolute address of the program counter. Any possible ambiguities in the information included in a sync marker can be resolved by the sync marker header information.

In the testing of a target processor, large amounts of information need to be transferred from the target processor to the host processing unit. Because of the large amount of data to be transferred within a limited bandwidth, every effort is provided to eliminate necessary information transfer. For example, the program counter trace stream, when the program is executed in a straight-forward manner and the sync ID markers are not present, would consist only of a first and last sync point marker. The execution of the program can be reconstructed as described with respect to FIG. 7A. The program counter trace streams includes sync markers only for events that interrupt/alter the normal instruction execution, such as branch sync markers, and debug halt sync markers.

It will also be clear that a data trace stream, as shown in FIG. 2, will typically be present. The periodic sync ID packets will also be included in the data trace stream in a manner similar to the addition on the packets to the timing trace stream.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. During the testing of the operation of a target processing unit having a plurality of processors, a system for synchronizing the trace streams from each of the processors, the system comprising:
a plurality of processors, each processor including:
timing trace apparatus responsive to signals from the processor unit, the timing trace apparatus generating a timing trace stream; and
program counter trace apparatus responsive to signals from the processing unit, the program counter trace apparatus generating a program counter trace stream; and
synchronization apparatus applying sync signals periodically to the timing trace apparatus and to the program counter trace apparatus, the timing trace apparatus including a sync marker in the timing trace stream in response to the sync signal, the program counter trace apparatus including a sync marker in response to the sync signal;
wherein the program counter trace apparatus of each processor is responsive to a global synchronization signal, the program counter trace apparatus of each processor generating global sync marker identifying the occurrence of the global synchronization signal and relating the occurrence of the global synchronization signal to the timing trace stream.

2. The system as recited in claim 1 wherein the global sync marker includes a global synchronization ID, a program counter address, a timing index and a sync signal ID.

3. The system as recited in claim 1 further comprising:
data trace apparatus responsive to signals from the processing unit, the data trace apparatus generating a data trace stream, wherein the sync signals are applied to the data trace apparatus, the data trace stream including a sync marker in response to the sync signal.

4. The system as recited in claim 3 wherein a host processing unit can relate the timing trace stream, the program counter trace stream and the data trace stream of all the processors.

5. The method for synchronizing the trace streams of a plurality of processing units, the method comprising:
generating a timing trace stream, a program counter trace stream, and data trace stream for each processing unit;
including sync markers in the in the trace streams of each processing unit permitting synchronization of the trace streams of each processing; and
in response to a global synchronization marker applied to each processing unit, including a global synchronization marker in at least one trace stream of each processing unit.

6. The method as recited in claim 5 further including:
in the global synchronization marker, including a global synchronization ID, the global synchronization ID identifying the global synchronization signal resulting in the global synchronization marker.

7. In a processing unit test environment wherein a target processor includes a plurality of processing units, each processing unit generating at least one trace stream, a global synchronization marker for inclusion in at least one trace stream for each processor, the marker comprising:
indicia identifying a global synchronization signal applied to the processing unit issuing the trace stream;
indicia of the relationship of the occurrence of the global synchronization signal to the clock of the processing unit issuing the trace stream; and
indicia of the relationship of the occurrence of the global synchronization signal to the processing unit program execution.

8. The marker as recited in claim 7 wherein the indicia of the relationship of the global synchronization signal to the processing unit program execution is a program counter address of the processing unit.

9. A system for testing the operation of a target processing unit, the target processing unit including a plurality of processing units, the system comprising:
a global signal synchronization generating unit;
each processing unit including;
a central processing unit; and
trace generating apparatus coupled to the central processing, the trace generating apparatus generating a least one trace stream;
wherein, the global signal generating unit applies a global synchronization signal to the trace generating apparatus of each processing unit, the global synchronization signal resulting in a global synchronization marker in at least one trace stream.

10. The system as recited in claim 9 wherein each trace generating unit generates a plurality of trace streams, each processing unit further including a periodic sync signal, the periodic sync signal being applied to the trace generating unit, the trace generating unit adding indicia to the plurality trace streams permitting the plurality of trace streams to be synchronized.

11. The system as recited in claim 9 wherein the global synchronization marker includes a global synchronization identification value and a value related to the processing unit clock.

12. The system as recited in claim 9 further comprising a host processing unit, the host processing unit using the trace streams to reconstruct the operation of the target processing unit.

13. The system as recited in claim 12 wherein the global synchronization markers permit the operation of the plurality of processors to be correlated.

14. The method of synchronizing the testing of a plurality of processing units, each processing unit including a trace generating unit for generating a plurality of trace streams, the method comprising:
applying a global synchronization signal to the trace generating unit of each processing unit;
generating in at least one trace stream of each processing unit a global synchronization marker in response to the global synchronization signal.

15. The method as recited in claim 14 wherein each trace stream of a processor includes sync markers relating the plurality of trace streams.
